(19) United States
(12) Patent Application Publication
(10) Pub. No.: US 2021/0261393 A1
(43) Pub. Date: Aug. 26, 2021

(54) VIBRATION SUPPRESSION SYSTEM FOR LOADING VEHICLE AND LOADING VEHICLE

(71) Applicant: MITSUBISHI HEAVY INDUSTRIES, LTD., Tokyo (JP)

(72) Inventors: Kengo IMAOKA, Tokyo (JP); Shoichi AOKI, Tokyo (JP); Kensuke FUTAHASHI, Tokyo (JP); Noriyuki HASEGAWA, Tokyo (JP); Koji UCHIDA, Tokyo (JP); Hiroyuki KONO, Tokyo (JP); Akihisa KAWAUCHI, Tokyo (JP)

(21) Appl. No.: 17/154,348

(22) Filed: Jan. 21, 2021

(30) Foreign Application Priority Data
Feb. 25, 2020 (JP) 2020-029536

(51) Int. Cl. B66F 9/075; B66F 9/22; B66F 9/24

(52) U.S. Cl. CPC B66F 9/07559; B66F 17/003; B66F 9/24; B66F 9/22

(57) ABSTRACT

A vibration suppression system for a loading vehicle includes: a sensor configured to detect a parameter indicating acceleration along a vertical direction of a load handling apparatus or of a vehicle main body of the loading vehicle; a vibration control force generating apparatus configured to apply a vibration control force for suppressing vibration of the loading vehicle; and a controller configured to generate a feedback command to be issued to the vibration control force generating apparatus based on a detection value of the sensor.

### CROSS-REFERENCE TO RELATED APPLICATIONS

This application claims the benefit of priority to Japanese Patent Application Number 2020-029536 filed on Feb. 25, 2020. The entire contents of the above-identified application are hereby incorporated by reference.

### TECHNICAL FIELD

The disclosure relates to a vibration suppression system for a loading vehicle and a loading vehicle.

### RELATED ART

In loading vehicles such as forklifts, it is important to suppress shaking when transporting loads or the like from the perspective of preventing damage to the load, maintaining performance of the vehicle, reducing fatigue of operators, and the like. In particular, when the load is a precision instrument, a very high level of shaking suppression performance is required.

JP 2005-112516 A discloses a vibration suppression system (a hydraulic apparatus for loading material) configured by connecting an accumulator to a supply and discharge oil passage via a branch oil passage provided with a pilot on-off valve and a diaphragm. The supply and discharge oil passage connects a lift cylinder that raises and lowers a fork and a manual switching valve provided with an operating lever.

In the vibration suppression system, the pilot on-off valve controls opening and closing (communication/blocking) with respect to the branch oil passage based on a pressure differential generated before and after the diaphragm when hydraulic oil is supplied from the manual switching valve to the lift cylinder. Furthermore, the vibration suppression system is configured so that, when a vehicle is traveling, the pressure differential increases and the pilot on-off valve is operated to transmit hydraulic oil to the branch oil passage and, by extension, to the accumulator, whereby vibration of the fork caused by vibration of a vehicle body is absorbed by a buffering action of the accumulator.

JP 2011-201433 A discloses a vibration suppression system including a vibration detection unit that detects pitching vibration of a vehicle body, and a pitching control unit that calculates a pitching control torque for reducing pitching vibration and generates a pitching control signal used for causing the pitching control torque to be output to an actuator. The vibration suppression system is configured so that, during load traveling, the pitching control unit calculates the pitching control torque based on a detection value of the vibration detection unit to output the pitching control signal, and controls the drive of the actuator based on the pitching control signal.

In this vibration suppression system, feedback control is performed based on the detection value of the vibration detection unit, and the pitching control torque is applied to the vehicle body as a driving force or a braking force of the actuator. As a result, pitching vibration of the vehicle can be suppressed.

### SUMMARY

However, in the vibration suppression system disclosed in JP 2005-112516 A in which the vibration suppression system is configured by providing the accumulator in a hydraulic circuit, the communication state of the accumulator is controlled to be switched based on a before-and-after pressure differential of a diaphragm 19, which is not a parameter that directly indicates load sway. Thus, the effect of suppressing load sway may not be sufficient. Similarly, even in the vibration suppression system that performs feedback control on a pitching torque based on the detection value of the vibration detection unit disclosed in JP 2011-201433 A, control is performed based on a lift pressure, which does not always directly reflect the effects of load sway, and the effect of suppressing the load sway may not be sufficient.

In light of the above circumstances, it is an object of the present disclosure to provide a vibration suppression system for a loading vehicle and a loading vehicle that can more effectively suppress vibration of a load.

According to one aspect of the present disclosure, there is provided a vibration suppression system for a loading vehicle, including: a sensor configured to detect a parameter indicating acceleration along a vertical direction of a load handling apparatus or of a vehicle main body of the loading vehicle; a vibration control force generating apparatus configured to apply a vibration control force for suppressing vibration of the loading vehicle; and a controller configured to generate a feedback command to be issued to the vibration control force generating apparatus based on a detection value of the sensor.

According to one aspect of the present disclosure, there is provided a loading vehicle including: a travelable vehicle main body; a load handling apparatus attached to the vehicle main body and configured to support a load; and the vibration suppression system of a loading vehicle.

With the vibration suppression system for a loading vehicle and the loading vehicle according to one aspect of the present disclosure, it is possible to effectively suppress load sway of a loading vehicle.

### BRIEF DESCRIPTION OF DRAWINGS

The disclosure will be described with reference to the accompanying drawings, wherein like numbers reference like elements.

FIG. 1 is a perspective view illustrating a loading vehicle (forklift) according to a first embodiment.

FIG. 2 is a diagram illustrating a vibration suppression system for the loading vehicle and a hydraulic circuit of the loading vehicle according to the first embodiment.

FIG. 3 is a diagram illustrating an example of a vehicle model of the loading vehicle (forklift) according to the first embodiment.

FIG. 4 is a diagram illustrating control blocks used in the description of an example of generating a braking force by using the vibration suppression system for the loading vehicle according to the first embodiment.

FIG. 5 is a diagram illustrating an example of a vibration suppression effect of the vibration suppression system for the loading vehicle and the loading vehicle according to the first embodiment.

FIG. 6 is a diagram illustrating a vibration suppression system for a loading vehicle and a loading vehicle according to a second embodiment.

FIG. 7 is a block diagram used in the description of an example of generating a braking force by using the vibration suppression system for the loading vehicle according to the second embodiment.

FIG. 8 is a diagram illustrating an example of a control method/control blocks of the vibration suppression system for the loading vehicle and a braking force generating apparatus (actuator) of the loading vehicle.

FIG. 9 is a diagram illustrating a vibration suppression system for a loading vehicle and a loading vehicle according to a third embodiment.

FIG. 10 is a diagram illustrating control blocks used in the description of an example of generating a braking force by using the vibration suppression system of the loading vehicle according to the third embodiment.

FIG. 11 is a diagram illustrating a modification example of the vibration suppression system for the loading vehicle and the loading vehicle according to the third embodiment.

FIG. 12 is a diagram illustrating control blocks used in the description of an example of generating a braking force by using the vibration suppression system for the loading vehicle of FIG. 11.

### DESCRIPTION OF EMBODIMENTS

### First Embodiment

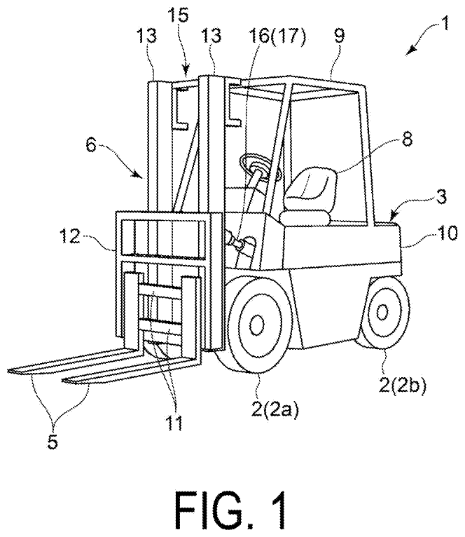

A vibration suppression system for a loading vehicle and a loading vehicle according to a first embodiment will be described below with reference to FIGS. 1 to 5. Here, in the present embodiment, the loading vehicle is described as being a forklift, but needless to say, but the loading vehicle need not be limited to a forklift.

### Loading Vehicle

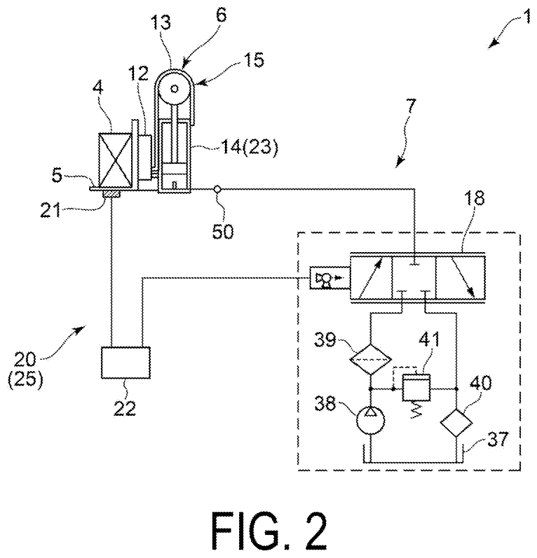

As illustrated in FIGS. 1 and 2, a loading vehicle 1 according to the present embodiment includes a vehicle main body 3 that is provided with wheels 2 which are tires, and that travels autonomously based on an operation by an operator, a load handling apparatus 6 that is attached to the vehicle main body 3 and is provided with a fork 5 for supporting/holding a load 4, a hydraulic circuit 7 used for controlling the drive of the load handling apparatus 6, and a controller 22 that controls the load handling apparatus (lift mechanism) 6 and the hydraulic circuit 7.

As illustrated in FIG. 1, for example, the vehicle main body 3 includes a pair of right and left front wheels 2a as drive wheels, a pair of right and left rear wheels 2b as driven wheels, a head guard 9 that is provided to enclose a driver's seat 8 to protect an operator, and a counter weight 10 attached to a rear portion of the vehicle main body 3.

As illustrated in FIGS. 1 and 2, the load handling apparatus 6 includes a pair of right and left forks 5 that hold the load 4, a backrest 12 including a fork rail 11 that slidably supports the pair of forks 5 on the right and left sides in the width direction, masts 13 that are attached to the vehicle main body 3 and support the backrest 12 and, by extension, the pair of forks 5 so that the forks 5 can be raised and lowered, a lifting apparatus 15 having a lift chain for raising and lowering the backrest 12 and a lift cylinder (mast cylinder, hydraulic cylinder) 14 for raising and lowering a load, and a tilting apparatus 17 including a tilt cylinder (hydraulic cylinder) 16 and being configured to tilt and undulate the masts 13 and, by extension, the pair of forks 5 to the front and rear.

The hydraulic circuit 7 includes an oil tank 37, a pump 38, a hydraulic filter 39, a cooler 40, a relief valve 41, and a servo valve 18, and is configured to control the servo valve 18 and the pump 38 by a control apparatus (a controller 22 described later in the present embodiment) to hydraulically drive the lift cylinder 14, the tilt cylinder 16, and the like.

### Vibration Suppression System

Meanwhile, as illustrated in FIG. 2, the loading vehicle 1 according to the present embodiment includes the vehicle main body 3, the load handling apparatus 6, and a vibration suppression system 20 for suppressing vibration of the load 4.

The vibration suppression system (vibration suppression mechanism) 20 of the loading vehicle 1 according to the present embodiment includes an accelerometer (sensor) 21, such as a piezoelectric element sensor, for detecting a parameter indicating acceleration along the vertical direction of at least one of the vehicle main body 3 and the load handling apparatus 6, the controller (control apparatus) 22 that receives a detection result of the accelerometer 21 and outputs a feedback command based on the detection result of the accelerometer 21, and an actuator 23 that is provided in the system of the hydraulic circuit 7 and is a braking force generating apparatus which controls the drive of the servo valve 18 based on the feedback command output from the controller 22 to suppress vibration of the load handling apparatus 6 and, by extension, the load 4.

In addition, the vibration suppression system 20 of the loading vehicle 1 according to the present embodiment includes a pressure sensor 50 configured to detect hydraulic pressure of the lift cylinder 14, and the controller 22 is configured to generate a drive signal for the servo valve 18 based on a difference between a target value of the hydraulic pressure of the lift cylinder 14 calculated from a detection value of the accelerometer 21 and a detection value of the pressure sensor 50.

Furthermore, in the present embodiment, the controller 22 is configured to calculate the target value of the hydraulic pressure by dividing a resultant force of an inertial force acting on the load handling apparatus 6 calculated from the detection value of the accelerometer 21 and a gravitational force acting on the load handling apparatus 6 by a pressure receiving area of the lift cylinder 14.

In the embodiment illustrated in FIG. 2, the accelerometer 21 is provided on the side of the load handling apparatus 6 and is configured to acquire a parameter indicating the acceleration of the load handling apparatus 6, that is, directly detect the vibration acting on the load 4.

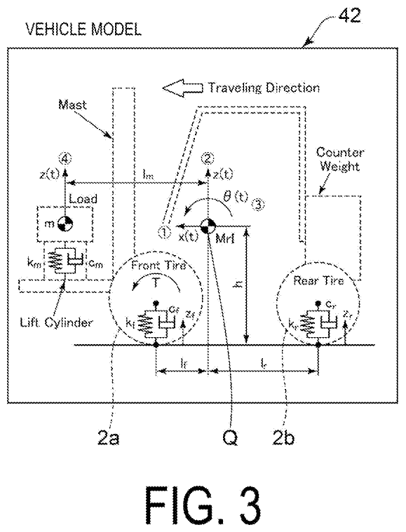

Note that in other embodiments, the accelerometer 21 is provided on the side of the vehicle main body 3 and is configured to acquire a parameter indicating the acceleration of the vehicle main body 3. In this case, the vibration acting on the load 4 (the load handling apparatus 6) may be obtained from the detection result of the accelerometer (sensor) 21 provided on the side of the vehicle main body 3, for example, by using a vehicle model 42 of the loading vehicle 1 as illustrated in FIG. 3, and control may be performed based on the obtained result.

FIG. 3 is a diagram illustrating an example of a kinematic model (vehicle model) of the loading vehicle 1.

As illustrated in FIG. 3, in the vehicle model 42, the front wheels 2a and the rear wheels 2b are represented by spring elements kf and kr and damping elements cf and cr, respectively, the lift cylinder 14 is represented by a spring element km and a damping element cm, and a portion of the load 4 and the load handling apparatus 6 that rises and falls together with the load 4 is represented by a mass m of a single-mass system. In addition, the mass of the vehicle main body 3, including the counter weight 10, is represented by Mr, h is a height from the floor (ground) of a center of gravity Q of the vehicle main body 3, lf is a distance in the front-rear direction from the center of gravity Q to the front wheels 2a, lr is a distance in the front-rear direction from the center of gravity Q to the rear wheels 2b, a position x(t) in the front-rear direction and a position z(t) in the height direction are the position of the center of gravity Q that changes during travel of the loading vehicle 1, a rotation angle θ(t) is the amount of rotation of the loading vehicle 1 about the center of gravity Q, and lm is a distance from the center of gravity Q to the mass m.

Note that the mass m can be calculated from the loading weight calculated from the pressure (lift pressure) of the lift cylinder 14 and the specifications of the load handling apparatus 6. Further, a spring constant of the spring element km of the lift cylinder 14 is determined according to the loading weight.

In the vehicle model 42, the moment is calculated by the product of the distances lf, lr, and lm from the center of gravity Q of the point of action of normal forces zf and zr received by the front wheels 2a and the rear wheels 2b from the floor (ground), respectively, and the gravitational load of the mass m and each load, and the product of the longitudinal force obtained by dividing the torque T for driving the front wheels by the tire radius and the height h from the center of gravity Q, to thereby calculate the angle θ(t) of the loading vehicle 1. In addition, the position z(t) in the height direction of the center of gravity Q of the vehicle main body 3 can be calculated from the accelerometer 21 provided in the vehicle main body 3. Then, the position z(t) in the height direction of the mass m is obtained by adding a displacement amount caused by the loading vehicle 1 rocking around the center of gravity Q, which is calculated from the distance lm and the angle θ(t) from the center of gravity Q to the mass m, and a displacement amount in the height direction of the vehicle main body 3 itself.

In this way, the vibration of the load 4 can be detected from the detection result of the accelerometer 21 provided on the side of the vehicle main body 3.

In this way, it is possible to convert the detection value of the accelerometer 21 provided on the side of the vehicle main body 3 into acceleration of the load handling apparatus 6 by using a known kinematic model of the loading vehicle 1 (for example, the vehicle model 42 illustrated in FIG. 3), to thereby calculate an inertial force from a converted value of the acceleration. Then, the controller 22 calculates a target value of the hydraulic pressure by dividing the resultant force of the inertial force and the gravitational force acting on the load handling apparatus 6 by the pressure receiving area of the lift cylinder 14, and controls the drive of the lift cylinder 14 based on the calculated value.

As a result, vibration acting on the load 4 (the load handling apparatus 6) can be effectively suppressed. In addition, when the accelerometer 21 is provided in the vehicle main body 3, the response performance with respect to vibration can be improved. Therefore, vibration can be more effectively suppressed.

Furthermore, in the present embodiment, the actuator 23 is described as being a lift cylinder 14, but the actuator 23 need not necessarily be limited to controlling and driving the servo valve 18 as long as vibration of the vehicle main body 3, the load handling apparatus 6, and by extension, the load 4 can be suppressed. That is, the actuator 23 may be provided separately, and the installation position of the actuator 23 and the quantity of actuators 23 are not particularly limited.

Next, in the vibration suppression system 20 for the loading vehicle 1 and the loading vehicle 1 according to the present embodiment configured as described above, the accelerometer 21 monitors the load sway, the actuator 23 is operated while controlling the drive of the servo valve 18 having an excellent response performance by feedback accordingly, and thereby vibration is suppressed so that vibration does not act on the load 4.

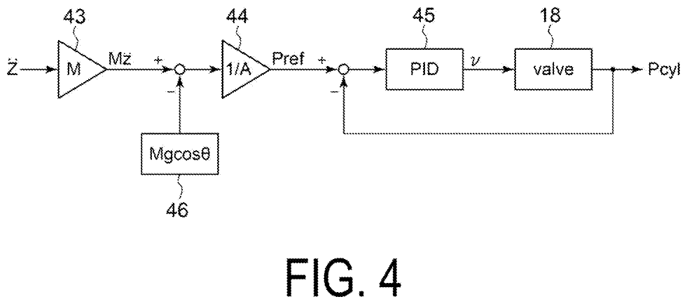

At this time, as illustrated in FIG. 4, a pressure P_{ref} required to cancel the vibration is calculated from an acceleration d²z/dt² detected by the accelerometer 21, a mass M of the portion of the load 4 and the load handling apparatus 6 that rises and falls together with the load 4, and a cross-sectional area A of a hydraulic pressure chamber of the lift cylinder 14. Further, the drive of the lift cylinder 14 (the actuator 23) is controlled to cancel the vibration by issuing a feedback command to the servo valve 18 by PID control of a PID control apparatus (Proportional-Integral-Differential Controller) 45 based on a deviation between the pressure P_{ref} as a target value and a measured hydraulic pressure value (P_{cyl}).

Note that in FIG. 4, reference sign 43 denotes a multiplier (calculator) that calculates the force acting on the load 4 and, by extension, the lift load acting by the detected acceleration by multiplying the acceleration d²z/dt² detected by the accelerometer 21 and the mass M of the load 4. Reference sign 44 denotes a divider (calculator) that calculates the pressure P_{ref} by dividing the force acting on the load 4 (the lift load acting by the detected acceleration) by the cross-sectional area A of the hydraulic pressure chamber of the lift cylinder 14.

In addition, in FIG. 4, reference sign 46 denotes a gravitational force calculator (load correction apparatus) 46, where the gravitational force calculator 46 is configured to convert the gravitational force acting on the portion of the load 4 and the load handling apparatus 6 that rises and falls together with the load 4 into a force component along the extending direction of the lift cylinder 14 in consideration of an inclination θ of the lift cylinder 14 with respect to the vertical direction. The gravitational force component along the extending direction of the lift cylinder 14, which is calculated by the gravitational force calculator 46, is subtracted from the value output from the multiplier 43, and is used to calculate the pressure target value P_{ref}.

Furthermore, in the present embodiment, the feedback command is issued to the servo valve 18 by a PID controller using the PID control apparatus 45, but a feedback controller including any PI controller can be used instead of the PID control apparatus 45.

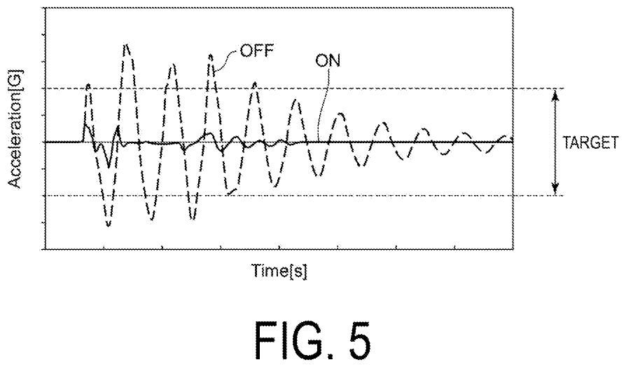

In this way, it is confirmed that, when the accelerometer 21 is installed in the load handling apparatus 6 and the drive of the lift cylinder 14 (the actuator 23) is controlled by controlling the servo valve 18 so that vibration is not transmitted to the load 4, that is, when active vibration control is performed using the vibration suppression system 20 for the loading vehicle 1 according to the present embodiment, as illustrated in FIG. 5, for example, vibration (maximum acceleration) acting on the load 4 is significantly reduced when the vibration suppression system 20 for the loading vehicle 1 according to the present embodiment is operated and active vibration control is turned on with vibration control (active vibration control) (vibration waveform indicated by the solid line in FIG. 5), as opposed to the vibration acting on the load 4 when the active vibration control is turned off without vibration control (active vibration control) (vibration waveform indicated by the dashed line in FIG. 5).

Thus, in the vibration suppression system 20 for the loading vehicle 1 (and the loading vehicle 1) according to the present embodiment configured as described above, because the system is an active vibration control system in which the accelerometer 21 is provided in the load handling apparatus 6, and which operates the actuator 23 by controlling the drive of a typical servo valve 18 having a response performance of approximately 20 to 100 (Hz), for example, with a phase delay of −90 deg by feedback, it is possible to effectively reduce, suppress, and cancel vibration with a high response.

In other words, in the vibration suppression system 20 for the loading vehicle 1 and the loading vehicle 1 according to the present embodiment, the system is configured so that the controller 22 outputs a feedback command based on the detection result of the accelerometer 21, and the actuator 23 (the lift cylinder 14) as the braking force generating apparatus is driven based on the feedback command output from the controller 22 to generate a braking force for suppressing vibration. Accordingly, response performance can be significantly improved, and an excellent vibration suppression effect can be obtained.

Thus, it is possible to realize the vibration suppression system 20 for a loading vehicle and the loading vehicle 1 that can more effectively suppress vibration of the load 4 than in the related art.

In addition, in the vibration suppression system 20 for the loading vehicle 1 and the loading vehicle 1 according to the present embodiment, the hydraulic circuit 7 that drives the hydraulic cylinder (the lift cylinder 14) of the load handling apparatus 6 is provided, and the accelerometer 21 is provided at a portion of the load handling apparatus 6 on the load 4 side of the hydraulic cylinder 14. Accordingly, the vibration acting on the load 4 supported/held by the load handling apparatus 6 can be directly and accurately captured.

As a result, even in a case where the kinematic model (the vehicle model 42) of the loading vehicle 1 illustrated in FIG. 3 is unknown, feedback control for suppressing load sway can be realized using the detection value of the accelerometer 21 provided on the side of the load handling apparatus 6.

Furthermore, in the vibration suppression system 20 for the loading vehicle 1 and the loading vehicle 1 according to the present embodiment, the system is configured so that the drive of the servo valve 18 in the hydraulic circuit 7 having a high response performance is controlled based on the feedback command from the controller 22, and the hydraulic cylinder, which is a vibration control force generating apparatus, is driven to suppress vibration. Accordingly, response performance can be further effectively improved, and an even more excellent vibration suppression effect can be obtained.

Note that if the flow path in the servo valve 18 is rectified in consideration of nonlinearity when the servo valve 18 switches between the feed side and the return side, more reliable vibration suppression can be achieved.

In addition, from the viewpoint of preventing a response delay of the servo valve 18 as much as possible, in other words, by providing a filtering function that filters an input when vibration expands or diverges due to the input of high frequency vibration or the like, an even more reliable vibration suppression effect can be obtained.

### Second Embodiment

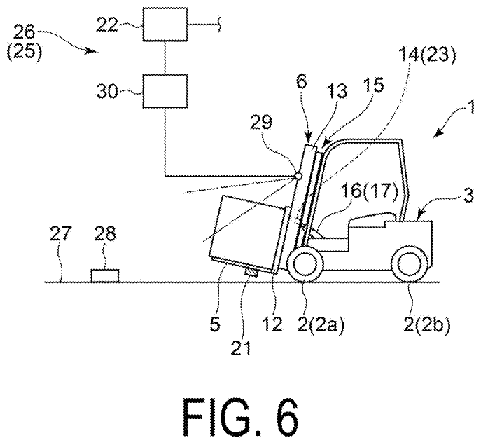

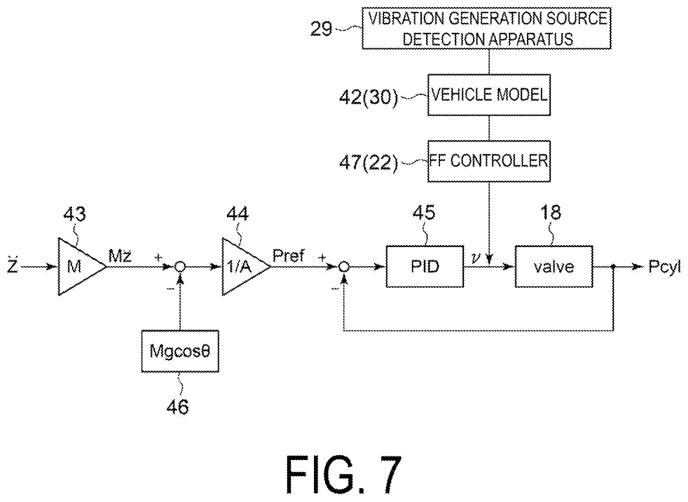

Next, a vibration suppression system for a loading vehicle and a loading vehicle according to a second embodiment will be described with reference to FIGS. 6 and 7 (and FIGS. 1 to 5). Here, in the present embodiment, the same components as those of the first embodiment are denoted by the same reference signs, and a detailed description thereof will be omitted.

### Loading Vehicle

A loading vehicle 1 according to the present embodiment includes a vehicle main body 3 provided with wheels 2, a load handling apparatus 6, a controller 22 that controls the load handling apparatus 6 (a hydraulic circuit 7), and a vibration suppression system 25 configured to suppress vibration of the vehicle main body 3, the load handling apparatus 6, and, by extension, a load 4 (see FIG. 6).

### Vibration Suppression System

The vibration suppression system (vibration suppression mechanism) 25 for the loading vehicle 1 according to the present embodiment includes a second vibration suppression system 26 that suppresses vibration by combining feed-forward control with feedback control similar to that of the first embodiment.

Similar to the first vibration suppression system 20 illustrated in the first embodiment, the second vibration suppression system 26 includes an accelerometer 21, such as a piezoelectric element sensor, for detecting a parameter indicating acceleration along the vertical direction of at least one of the vehicle main body 3 and the load handling apparatus 6, the controller 22 that receives a detection result of the accelerometer 21 and outputs a feedback command based on the detection result of the accelerometer 21, and an actuator (braking force generating apparatus) 23 that is provided in the system of the hydraulic circuit 7 and is drive-controlled to suppress vibration of the load handling apparatus 6 and, by extension, the load 4 by controlling the drive of a servo valve 18 by using the feedback command output from the controller 22 (see FIGS. 6, 1, and 2).

As illustrated in FIG. 6, the second vibration suppression system 26 includes a vibration generation source detection apparatus 29, such as an optical apparatus, which detects a vibration generation source (disturbance element) 28 such as recesses and projections on the road surface of a traveling path 27 in front of the loading vehicle 1 in the traveling direction or an obstacle on the traveling path 27, a vibration prediction apparatus 30 that analyzes and predicts the degree of vibration generated by the vibration generation source 28 detected by the vibration generation source detection apparatus 29, and, by extension, the degree of load sway, the controller (control apparatus) 22 that outputs a feed-forward command so that the vibration predicted by the vibration prediction apparatus 30 is dampened or canceled, and an actuator (braking force generating apparatus) 23 that is drive-controlled to suppress vibration of the load handling apparatus 6 and, by extension, the load 4 (and/or the vehicle main body 3) by using the feed-forward command output from the controller 22.

Furthermore, as illustrated in FIG. 7, the second vibration suppression system 26 includes calculators such as a multiplier 43 and a divider 44 similar to those in the first embodiment, a PID control apparatus 45, a load correction apparatus 46, and a feed-forward controller 47 (the controller 22) that outputs a feed-forward command so as to cancel vibration that is predicted by the vibration prediction apparatus 30 using the vehicle model 42, the vibration acting on the load handling apparatus 6 and the load 4 and being generated by the vibration generation source 28 detected by the vibration generation source detection apparatus 29.

Note that in the present embodiment, the vibration generation source detection apparatus 29 is attached to the load handling apparatus 6. Further, in the present embodiment, “front in the traveling direction” means the front of the drive wheels 2a when the loading vehicle 1 moves forward, and means the rear of the driven wheels 2b when the loading vehicle 1 moves backward. The installation position and quantity of the vibration generation source detection apparatus 29 may be appropriately determined so that vibration can be suppressed by reliably detecting the vibration generation source 28.

Furthermore, in the present embodiment, as in the first embodiment, the actuator 23 is described as being the lift cylinder 14 (and/or a tilt cylinder 16), but the actuator 23 need not necessarily be limited to controlling and driving the servo valve 18 as long as vibration of the vehicle main body 3, the load handling apparatus 6, and, by extension, the load 4 can be suppressed. That is, the actuator 23 may be provided separately, and the installation position of the actuator 23 and the quantity of actuators 23 are not particularly limited.

In the vibration suppression system 26 for the loading vehicle 1 according to the present embodiment having the above-described configuration, similar to the first vibration suppression system 20, the operational effect of vibration suppression caused by feedback control can be obtained.

In addition, the second vibration suppression system 26 includes the feed-forward controller 47 to enhance the vibration suppression effect. In other words, in the second vibration suppression system 26, the vibration generation source detection apparatus 29 detects a profile (the vibration generation source 28) such as recesses and projections on the traveling path 27 where the vehicle will travel, and the vibration prediction apparatus 30 predicts the vibration acting on the load handling apparatus 6 and the load 4 when passing through the location where the disturbance generation source is present by using a calculation result of height data for each distance, the vehicle model 42, and the like, for example. A feed-forward command to offset the vibration displacement is then output from the controller 22 (the feed-forward controller 47) to control the drive of the actuator 23 based on the feed-forward command. As a result, it is possible to perform control in advance to minimize load sway.

Note that the vibration prediction apparatus 30 may perform self-position estimation with, for example, a laser sensor or a camera, store data on a storage apparatus including information of the vibration generation source 28 such as measured step information, vibration prediction data corresponding to this information, and the like, and create a map of the vibration generation source 28 such as a step position with a map creation apparatus. In this case, by using the map, it is possible to predict/foresee the vibration generation source 28, such as a step position, earlier along the traveling path 27 that has passed once, and it is possible to perform vibration suppression with leeway.

In this way, in the vibration suppression system 25 for the loading vehicle 1 and the loading vehicle 1 according to the present embodiment, by outputting the feed-forward command for suppressing the vibration predicted by the vibration prediction apparatus 30 and controlling the actuator 23 as the braking force generating apparatus based on the feedback command, information regarding the vibration generation source 28 can be captured before traveling on the traveling path 27, and feed-forward control can be performed based on this information.

As illustrated in FIG. 7, the feed-forward command output from the feed-forward controller 47 may be added to the feedback command output from the feedback controller (the PID controller 45) to generate a command signal to the servo valve 18.

Further, the specific method of vibration prediction performed by the vibration prediction apparatus 30 and the command calculation performed by the feed-forward controller 47 is not particularly limited, but the vehicle model 42 described above with reference to FIG. 3 may be used to predict vibration from a detection result of recesses and projections by the vibration generation source detection apparatus 29 and calculate a feed-forward command for suppressing the vibration.

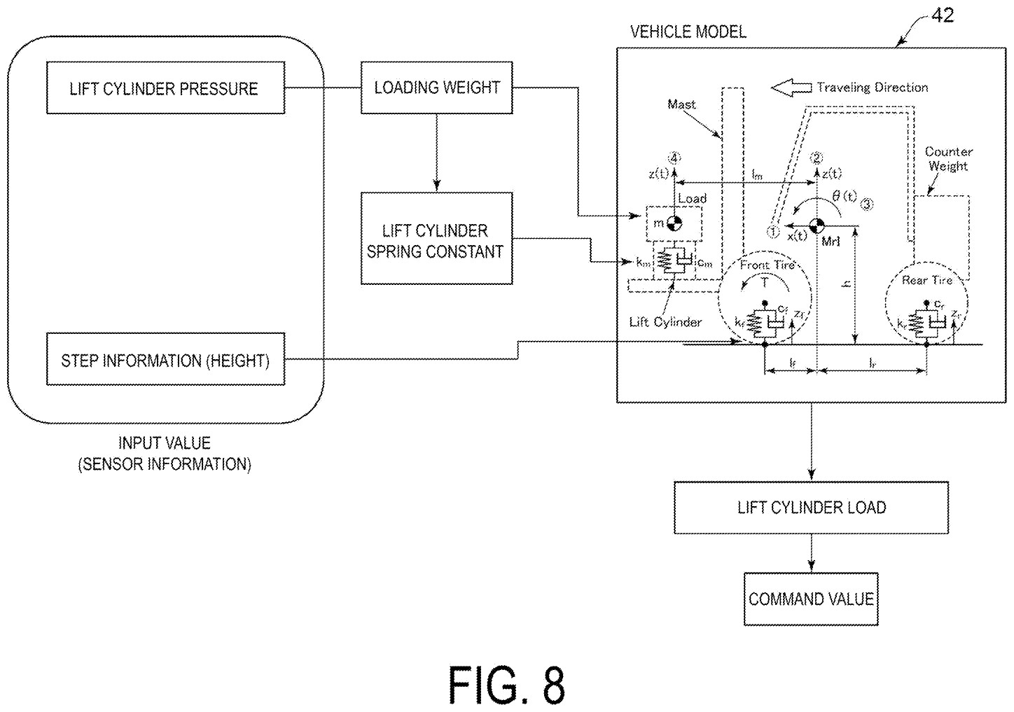

For example, as illustrated in FIG. 8, the pressure (lift pressure) of the lift cylinder 14 and the detection result of recesses and projections (step information) obtained by the vibration generation source detection apparatus 29 may be input to the vehicle model 42 to generate a feed-forward command value used for suppressing the vibration expected to be caused by the recesses and projections. Specifically, when the detection result of recesses and projections (step information) from the vibration generation source detection apparatus 29 is obtained, the time required for the loading vehicle 1 to reach the position of the recesses and projections is determined from a vehicle speed dx(t)/dt. Then, at the time of reaching the recesses and projections, the displacement z(t) in the height direction of the load 4 generated when the loading vehicle 1 passes over the recesses and projections is calculated using the vehicle model 42. As the vehicle model 42, the one described above with reference to FIG. 3 can be used. A lift cylinder load required to offset the variable component of the displacement z(t) in the height direction of the load 4 is calculated, and the feed-forward command to be issued to the servo valve 18 can be determined from the lift cylinder load.

### Third Embodiment

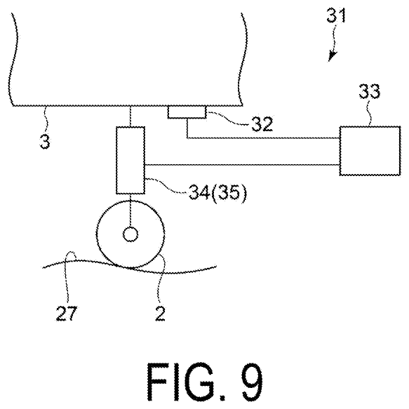

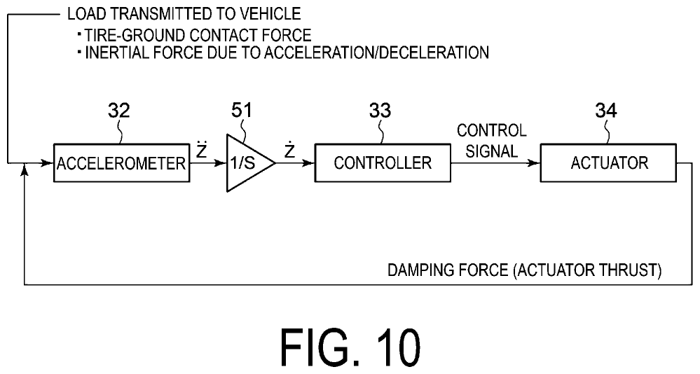

Next, a vibration suppression system for a loading vehicle and a loading vehicle according to a third embodiment will be described with reference to FIGS. 9 and 10 (and FIGS. 1 and 5). Here, in the present embodiment, the same components as those of the first embodiment and the second embodiment are denoted by the same reference signs, and a detailed description thereof will be omitted.

### Loading Vehicle

A loading vehicle 1 according to the present embodiment includes a vehicle main body 3 provided with wheels 2, a load handling apparatus 6, a controller 33 that controls the load handling apparatus 6 (a hydraulic circuit 7), and a vibration suppression system 31 configured to suppress vibration of the vehicle main body 3, the load handling apparatus 6, and, by extension, a load 4 (see FIG. 1).

### Vibration Suppression System

As illustrated in FIG. 9, the vibration suppression system (vibration suppression mechanism) 31 for the loading vehicle according to the present embodiment includes an accelerometer (sensor) 32, such as a piezoelectric element sensor, for detecting a parameter indicating acceleration along the vertical direction of at least one of the vehicle main body 3 and the load handling apparatus 6, the controller (control apparatus) 33 that receives a detection result of the accelerometer 32 and outputs a feedback command based on the detection result of the accelerometer 32, and an actuator (braking force generating apparatus, vibration control actuator) 34 that is provided between the wheels 2 and the vehicle main body 3 and is drive-controlled to suppress vibration of the vehicle main body 3 (and by extension, the load handling apparatus 6 and the load 4) by the feedback command output from the controller 33.

As the braking force generating apparatus, the actuator 34 such as a hydraulic cylinder or an electric cylinder, for example, can be employed.

In the vibration suppression system 31 for the loading vehicle 1 and the loading vehicle 1 according to the present embodiment having the above-described configuration, the accelerometer 32 in FIGS. 9 and 10 monitors the sway of the vehicle main body 3 and the like, and the actuator 34 is operated by feedback control accordingly to suppress the vibration.

For example, in the present embodiment, the controller 33 issues a feedback command to the actuator 34 so that the vehicle main body 3 is driven in a reverse phase with respect to a velocity component of the vehicle main body 3, which is calculated from the detection value of the accelerometer 32.

Here, in the vibration suppression system 31 for the loading vehicle according to the present embodiment, the skyhook theory is applied in performing feedback drive control of the actuator 34 using the accelerometer 32.

The skyhook theory is a theory that shows that an object can always be kept in a stable posture if it can be moved in a suspended state (skyhook) on an imaginary line running through the sky.

Here, in the skyhook theory, a spring is interposed between the vehicle body and the ground, a damper is interposed between an imaginary horizontal straight line and the vehicle body, and the vehicle body is supported by the spring below it and the damper above it. When the coefficient of the damper reaches an infinite value, the vehicle body is fixed to the imaginary line and does not shake.

In a normal vehicle, a damper spring suspension is used, and the vehicle main body 3 is subject to normal force from the ground through the damper and spring. On the other hand, in the vibration suppression system 31 for the loading vehicle 1 and the loading vehicle 1 according to the present embodiment to which the skyhook theory is applied, the support structure of the skyhook theory is to be realized by an active suspension comprising the accelerometer 32 and the actuator 34 provided between the wheels 2 and the vehicle main body 3.

In other words, an imaginary line (acceleration=0) that does not vibrate at all is calculated based on the detection result of the accelerometer 32 installed in the vehicle main body 3 (or the load handling apparatus 6), and the drive of the actuator 34 is controlled to be consistent with a skyhook model.

Specifically, as illustrated in FIG. 10, the load is transmitted to the vehicle main body 3 (the loading vehicle 1) by the tire-ground contact force and the inertial force due to acceleration/deceleration, and the acceleration detected by the accelerometer 32 is integrated by a calculator 51 to calculate the velocity component in the vertical direction of the vehicle main body 3.

The controller 33 then issues a feedback command to the actuator 34 to achieve a damping force in the opposite direction from the velocity component so that the calculated velocity component is 0 (zero).

Here, the velocity component in the vertical direction of the vehicle main body 3 in which vibration is generated repeatedly varies over time, and the direction of the velocity component also changes between the vertical upward direction and the vertical downward direction. Therefore, for example, an output waveform with a reverse phase with respect to a velocity is generated by multiplying a vehicle speed by a preset gain, the waveform obtained by multiplying the preset appropriate gain is used as a feedback command (control signal) to drive the actuator 34, and a damping force, which is a reverse phase of the velocity component in the vertical direction of the vehicle main body 3 which changes every moment, is generated.

As a result, the actuator 34 can simulate the damper in the skyhook theory, and the skyhook theory can be achieved.

Note that in this control, complex calculations are not required because the mechanical elements can be composed only of linear springs and linear dampers.

In this way, as in FIG. 5 illustrated in the first embodiment, it is confirmed that, when active vibration control is performed using the vibration suppression system 20 for the loading vehicle 1 according to the present embodiment, vibration/maximum acceleration acting on the load 4 is significantly reduced when the vibration suppression system 31 for the loading vehicle 1 according to the present embodiment is operated and active vibration control is turned on with vibration control/active vibration control (vibration waveform indicated by solid lines in FIG. 5), as opposed to the vibration acting on the load 4 when the active vibration control is turned off without vibration control/active vibration control (vibration waveform indicated by the dashed line in FIG. 5, for example, vibration of several Hz to several tens of Hz).

Thus, in the vibration suppression system 31 for the loading vehicle 1 and the loading vehicle 1 according to the present embodiment, because the system is an active vibration control system that operates the actuator 34 to dampen vibration based on the skyhook theory, it is possible to effectively suppress vibration with a higher response than in the related art.

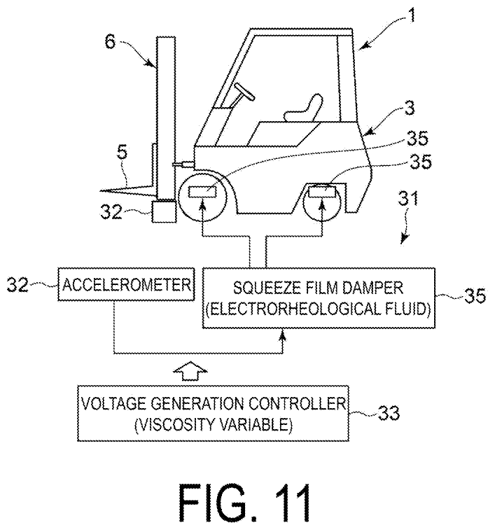

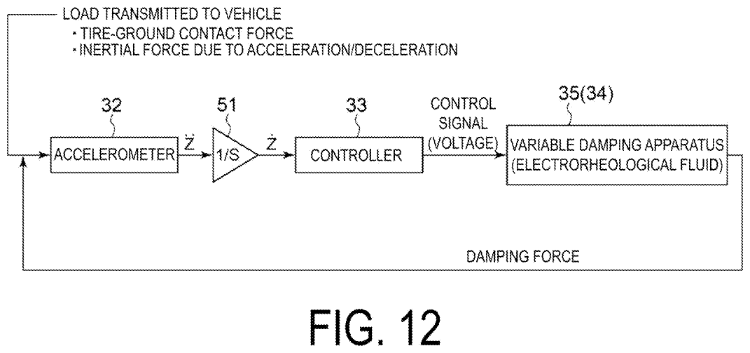

Here, in the present embodiment, the vibration suppression system 31 has a configuration in which the actuator 34 as a braking force generating apparatus is provided between the wheels 2 and the vehicle main body 3. However, as illustrated in FIGS. 11 and 12, instead of the actuator 34, a variable damping apparatus 35 that effectively dampens and reduces vibration by changing a damping coefficient based on the detection result (acceleration along the vertical direction) of the accelerometer 32 may be used as the braking force generating apparatus.

Examples of the variable damping apparatus 35 include a squeeze film damper provided with an electrorheological fluid (for example, a medium such as a poly α-olefin interspersed with fine particles such as iron powder) that changes the damping coefficient by applying a voltage based on the detection result of the accelerometer 32 and changing the viscosity depending on the magnitude of the applied voltage.

When the variable damping apparatus 35 is used in this way, as illustrated in FIG. 12, the load is transmitted to the vehicle main body 3 (the loading vehicle 1) by the tire-ground contact force and the inertial force due to acceleration/deceleration, and the acceleration detected by the accelerometer 32 is integrated by the calculator 51 to calculate the velocity component in the vertical direction of the vehicle main body 3.

The controller (voltage generation controller) 33 then issues a feedback command to the variable damping apparatus 35 to achieve a damping force in the opposite direction from the velocity component so that the calculated velocity component is 0 (zero).

For example, when the variable damping apparatus 35 is a squeeze film damper, the controller 33 adjusts the voltage applied to the electrorheological fluid according to the magnitude of the measured speed (calculated velocity component). That is, when the speed is high, the applied voltage is increased to provide a large damping force, and when the speed is low, the applied voltage is decreased to provide a small damping force.

Further, the relationship between the applied voltage of the electrorheological fluid and damping characteristics is acquired in advance such that the controller 33 adjusts the applied voltage based on the relationship between the applied voltage of the electrorheological fluid and the damping characteristics. In addition, the relationship between the speed and the optimal damping coefficient is acquired in advance, and the optimal damping coefficient is obtained from the measured speed to derive the applied voltage.

As a result, by providing the derived applied voltage to the electrorheological fluid as a feedback command, the damping characteristics of the variable damping apparatus 35 can be changed, and a damping force, which is a reverse phase of the velocity component in the vertical direction of the vehicle main body 3 which changes every moment, can be generated.

Accordingly, the variable damping apparatus 35 can simulate the damper in the skyhook theory, and the skyhook theory can be achieved.

Therefore, by providing such a variable damping apparatus 35 between the vehicle main body 3 and the wheels 2 and controlling the drive of the variable damping apparatus 35 based on the detection result of the accelerometer 32 provided in the vehicle main body 3 or the load handling apparatus 6, the same operational effects as those of the present embodiment can be obtained. That is, it is possible to realize an active vibration control system that operates the actuator to dampen vibration based on the skyhook theory, and it is also possible to effectively suppress vibration with a higher response than in the related art.

The vibration suppression system for the loading vehicle and the loading vehicle according to each of the first embodiment, the second embodiment, and the third embodiment have been described above, but the vibration suppression system for the loading vehicle and the loading vehicle of the present disclosure are not limited to the first embodiment, the second embodiment, and the third embodiment described above, and modifications can be made as appropriate within a range that does not deviate from the spirit of the present disclosure.

For example, in each embodiment, the vehicle main body 3 of the loading vehicle 1 is provided with tires (the wheels 2) and is configured to be able to autonomously travel, but the traveling unit of the vehicle main body 3 of the loading vehicle 1 need not necessarily be tires. Further, the vehicle main body 3 need not necessarily be a self-traveling type as long as the vehicle main body 3 can travel.

Furthermore, in each embodiment, the load handling apparatus 6 of the loading vehicle 1 has been described as being driven by hydraulic pressure, but the load handling apparatus 6 (or the loading vehicle 1) may be electrically driven. In this case, the same operational effects can be obtained if the braking force generating apparatus of each embodiment is replaced with an electric motor (motor) as appropriate, the lift pressure is replaced with a current value of the electric motor, and the drive of the electric motor is controlled in the same manner as in each embodiment based on the current value and the detection value of the accelerometer.

In addition, in the first embodiment and the second embodiment, the accelerometer 21 is provided at a portion on the load side of the lift cylinder 14, but the accelerometer 21 may be provided in the vehicle main body 3 as long as it is possible to obtain and control the braking force used for accurately and suitably suppressing the vibration acting on the load based on the detection result of the accelerometer 21 in consideration of spring rigidity of the lift cylinder 14.

When the accelerometer 21 is provided in the vehicle main body 3 in this manner, if the sway (vibration waveform) of the load 4 is calculated and predicted from the detection result of the accelerometer 21, the model of the loading vehicle 1, and the like, and the drive of the lift cylinder 14 is controlled to offset the vibration, it is possible to suitably suppress the vibration acting on the load 4. In addition, when the accelerometer 21 is provided in the vehicle main body 3, the response performance with respect to vibration can be improved. Therefore, vibration can be more effectively suppressed.

Further, in the second embodiment, when vibration can be sufficiently suppressed by the feed-forward control of the second vibration suppression system 26, the first vibration suppression system 20 need not necessarily be provided.

Furthermore, the second vibration suppression system 26 may include an accelerometer, a controller (control apparatus), and an actuator separate from the first vibration suppression system 20.

In addition, the configurations of the first embodiment, the second embodiment, and the third embodiment, modification examples, and the like may be selectively combined as appropriate, and the vibration suppression system for the loading vehicle and the loading vehicle may be configured by using the first vibration suppression system 20 and the second vibration suppression system 26 of the second embodiment individually.

Finally, the contents of the embodiments described above can be understood as follows, for example.

(1) A vibration suppression system (the vibration suppression systems 20 and 25 of the first to third embodiments) for a loading vehicle according to one aspect includes: a sensor (the accelerometers 21 and 32 of the first to third embodiments) configured to detect a parameter indicating acceleration along a vertical direction of a load handling apparatus (the load handling apparatus 6 of the first to third embodiments) or of a vehicle main body (the vehicle main body 3 of the first to third embodiments) of the loading vehicle (the loading vehicle 1 of the first to third embodiments); a vibration control force generating apparatus (the lift cylinder 14, the hydraulic cylinder, the actuators (load handling actuators) 23 and 34, and the variable damping apparatus 35 of the first to third embodiments) configured to apply a vibration control force for suppressing vibration of the loading vehicle; and a controller (the controllers 22 and 33 of the first to third embodiments) configured to generate a feedback command to be issued to the vibration control force generating apparatus based on a detection value of the sensor.

According to the vibration suppression system for a loading vehicle of the present disclosure, because the sensor directly detects the parameter indicating acceleration along the vertical direction of the load handling apparatus or of the vehicle main body and generates the feedback command to be issued to the vibration control force generating apparatus based on the detection value, it is possible to effectively suppress the load sway of the loading vehicle.

(2) A vibration suppression system for a loading vehicle according to another aspect is the vibration suppression system of a loading vehicle according to (1), in which the vibration control force generating apparatus includes a load handling actuator of the load handling apparatus, and the controller is configured to generate the feedback command for adjusting a driving force of the load handling actuator based on the detection value.

According to the vibration suppression system for a loading vehicle of the present disclosure, by using the load handling actuator provided in the load handling apparatus included in the loading vehicle as the vibration control force generating apparatus, load sway can be suppressed with a simple configuration.

(3) A vibration suppression system for a loading vehicle according to another aspect is the vibration suppression system of a loading vehicle according to (2), in which the load handling actuator is a lift cylinder for raising and lowering a load, and the vibration suppression system further includes a servo valve configured to adjust a hydraulic pressure of the lift cylinder, and a pressure sensor (the pressure sensor 50 of the first and second embodiments) configured to detect the hydraulic pressure of the lift cylinder, and the controller is configured to generate a drive signal of the servo valve based on a deviation between a target value of the hydraulic pressure of the lift cylinder calculated from the detection value of the sensor and a detection value of the pressure sensor.

According to the vibration suppression system for a loading vehicle of the present disclosure, because the servo valve has excellent responsiveness, a sufficient vibration control effect can be obtained in relation to a typical vibration frequency (for example, several Hz to several tens of Hz) to be a vibration control target.

(4) A vibration suppression system for a loading vehicle according to another aspect is the vibration suppression system of a loading vehicle according to (3), in which the sensor is an accelerometer provided in the load handling apparatus, and the controller is configured to calculate the target value of the hydraulic pressure by dividing a resultant force of an inertial force acting on the load handling apparatus calculated from a detection value of the accelerometer and a gravitational force acting on the load handling apparatus by a pressure receiving area of the lift cylinder.

According to the vibration suppression system for a loading vehicle of the present disclosure, because the target value of the hydraulic pressure is calculated by dividing the resultant force of the inertial force acting on the load handling apparatus calculated from the detection value of the accelerometer and the gravitational force acting on the load handling apparatus by the pressure receiving area of the lift cylinder, a drive signal for the servo valve can be generated with high accuracy. This makes it possible to more effectively suppress the vibration of the load.

(5) A vibration suppression system for a loading vehicle according to another aspect is the vibration suppression system of a loading vehicle according to (4), in which the accelerometer is provided in the load handling apparatus.

According to the vibration suppression system for a loading vehicle of the present disclosure, unlike a case where the accelerometer is provided on the side of the vehicle main body of the loading vehicle, even if the kinematic model that describes the relationship between the vehicle main body and the load handling apparatus is unknown, the target value of the hydraulic pressure can be directly calculated from the detection value of the accelerometer. As a result, the vibration acting on the load supported/held by the load handling apparatus can be directly and accurately measured. Accordingly, it is possible to more effectively improve the response performance, which makes it possible to obtain a more excellent vibration suppression effect.

(6) A vibration suppression system for a loading vehicle according to another aspect is the vibration suppression system of a loading vehicle according to (4), in which the accelerometer is provided in the vehicle main body, and the controller is configured to convert the detection value of the accelerometer into an acceleration of the load handling apparatus by using a known kinematic model of the loading vehicle, to thereby calculate the inertial force from a converted value of the acceleration.

According to the vibration suppression system for a loading vehicle of the present disclosure, by providing an accelerometer on the side of the vehicle main body of the loading vehicle, it is possible to issue the vibration control force generating apparatus with a feedback command capable of suppressing the load sway before the vibration of the vehicle main body is transmitted to the load, which makes it possible to improve responsiveness of control.

Accordingly, an even more excellent vibration suppression effect can be obtained.

(7) A vibration suppression system for a loading vehicle according to another aspect is the vibration suppression system of a loading vehicle according to any one of (1) to (6), the vibration suppression system further including: a vibration generation source detection apparatus (the vibration generation source detection apparatus 29 of the second embodiment) configured to detect a vibration generation source (the vibration generation source 28 of the second embodiment) existing in front of the loading vehicle in a traveling direction; and a vibration prediction apparatus (the vibration prediction apparatus 30 of the second embodiment) configured to predict vibration generated by the vibration generation source detected by the vibration generation source detection apparatus, in which the controller is configured to output a feed-forward command for suppressing the vibration predicted by the vibration prediction apparatus, and control the vibration control force generating apparatus based on the feedback command and the feed-forward command.

According to the vibration suppression system for a loading vehicle of the present disclosure, by outputting the feed-forward command for suppressing the vibration predicted by the vibration prediction apparatus and controlling the vibration control force generating apparatus based on the feedback command, information regarding the vibration generation source can be captured in advance, and feed-forward control can be performed based on this information.

Accordingly, the vibration acting on the load can be suppressed by the feedback control performed by the vibration suppression system according to any one of (1) to (6) and the feed-forward control performed by the vibration suppression system according to (7), and it is possible to effectively suppress vibration with a higher response.

(8) A vibration suppression system for a loading vehicle according to another aspect is the vibration suppression system of a loading vehicle according to (1), in which the vibration control force generating apparatus is provided between wheels (the wheels 2 of the first to third embodiments) and the vehicle main body, and is configured to be driven based on the feedback command output from the controller.

According to the vibration suppression system for a loading vehicle of the present disclosure, because the vibration control force generating apparatus is provided between the wheels and the vehicle main body, it is possible to effectively suppress vibration with a higher response than in the related art by generating the vibration control force to suppress the vibration.

For example, by generating a damping force that is a reverse phase of the velocity component in the vertical direction of the vehicle main body, based on the detection result of the accelerometer, the vibration of the vehicle main body can be effectively suppressed based on the skyhook theory.

(9) A vibration suppression system for a loading vehicle according to another aspect is the vibration suppression system of a loading vehicle according to (8), in which the sensor is an accelerometer provided in the vehicle main body, the vibration control force generating apparatus is a vibration control actuator (the actuator 34 of the third embodiment) provided between the wheels and the vehicle main body, and the controller is configured to issue the feedback command to the vibration control actuator so that the vehicle main body is driven in a reverse phase with respect to a velocity component of the vehicle main body, the velocity component being calculated from a detection value of the accelerometer.

According to the vibration suppression system for a loading vehicle of the present disclosure, it is possible to effectively suppress vibration by issuing the feedback command to the vibration control actuator so that the vehicle main body is driven in the reverse phase with respect to the velocity component of the vehicle main body, which is calculated from the detection value of the accelerometer.

(10) A vibration suppression system for a loading vehicle according to another aspect is the vibration suppression system of a loading vehicle according to (8), in which the vibration control force generating apparatus is a variable damping apparatus (the variable damping apparatus 35 of the third embodiment) provided between the wheels and the vehicle main body, and the vibration control force generating apparatus is configured to generate the feedback command for adjusting a damping coefficient of the variable damping apparatus based on a magnitude of the detection value of the sensor.

According to the vibration suppression system for a loading vehicle of the present disclosure, because the variable damping apparatus is provided between the vehicle main body and the wheels and is drive-controlled based on the detection value of the sensor provided in the vehicle main body or the load handling apparatus, it is possible to realize an active vibration control system that operates the variable damping apparatus to dampen vibration based on, for example, the skyhook theory, and it is possible to effectively suppress vibration with a higher response than in the related art. (11) A loading vehicle according to one aspect includes: a vehicle main body capable of travel; a load handling apparatus attached to the vehicle main body and configured to support a load; and the vibration suppression system for a loading vehicle according to any one of (1) to (10).

According to the loading vehicle of the present disclosure, it is possible to provide a loading vehicle that achieves the operational effects of the vibration suppression system for a loading vehicle according to (1) to (10) above.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A vibration suppression system for a loading vehicle, comprising:
a sensor configured to detect a parameter indicating acceleration along a vertical direction of a load handling apparatus or of a vehicle main body of the loading vehicle;
a vibration control force generating apparatus configured to apply a vibration control force for suppressing vibration of the loading vehicle; and
a controller configured to generate a feedback command to be issued to the vibration control force generating apparatus based on a detection value of the sensor.

2. The vibration suppression system for a loading vehicle according to claim 1, wherein
the vibration control force generating apparatus includes a load handling actuator of the load handling apparatus, and
the controller is configured to generate the feedback command for adjusting a driving force of the load handling actuator based on the detection value.

3. The vibration suppression system for a loading vehicle according to claim 2, wherein
the load handling actuator is a lift cylinder for raising and lowering a load,
the vibration suppression system further comprises a servo valve configured to adjust a hydraulic pressure of the lift cylinder, and a pressure sensor configured to detect the hydraulic pressure of the lift cylinder, and
the controller is configured to generate a drive signal of the servo valve based on a deviation between a target value of the hydraulic pressure of the lift cylinder calculated from the detection value of the sensor and a detection value of the pressure sensor.

4. The vibration suppression system for a loading vehicle according to claim 3, wherein
the sensor is an accelerometer provided in the load handling apparatus, and
the controller is configured to calculate the target value of the hydraulic pressure by dividing a resultant force of an inertial force acting on the load handling apparatus calculated from a detection value of the accelerometer and a gravitational force acting on the load handling apparatus by a pressure receiving area of the lift cylinder.

5. The vibration suppression system for a loading vehicle according to claim 4, wherein the accelerometer is provided in the load handling apparatus.

6. The vibration suppression system for a loading vehicle according to claim 4, wherein
the accelerometer is provided in the vehicle main body, and
the controller is configured to convert the detection value of the accelerometer into an acceleration of the load handling apparatus by using a known kinematic model of the loading vehicle, to thereby calculate the inertial force from a converted value of the acceleration.

7. The vibration suppression system for a loading vehicle according to claim 1, further comprising:
a vibration generation source detection apparatus configured to detect a vibration generation source existing in front of the loading vehicle in a traveling direction; and
a vibration prediction unit configured to predict vibration generated by the vibration generation source detected by the vibration generation source detection apparatus, wherein the controller is configured to
output a feed-forward command for suppressing the vibration predicted by the vibration prediction unit, and
control the vibration control force generating apparatus based on the feedback command and the feed-forward command.

8. The vibration suppression system for a loading vehicle according to claim 1, wherein the vibration control force generating apparatus is provided between wheels and the vehicle main body, and is configured to be driven based on the feedback command output from the controller.

9. The vibration suppression system for a loading vehicle according to claim 8, wherein
the sensor is an accelerometer provided in the vehicle main body,
the vibration control force generating apparatus is a vibration control actuator provided between the wheels and the vehicle main body, and
the controller is configured to issue the feedback command to the vibration control actuator so that the vehicle main body is driven in a reverse phase with respect to a velocity component of the vehicle main body, the velocity component being calculated from a detection value of the accelerometer.

10. The vibration suppression system for a loading vehicle according to claim 8, wherein
the vibration control force generating apparatus is a variable damping apparatus provided between the wheels and the vehicle main body, and
the vibration control force generating apparatus is configured to generate the feedback command for adjusting a damping coefficient of the variable damping apparatus based on a magnitude of the detection value of the sensor.

11. A loading vehicle comprising:
a vehicle main body capable of travel;
a load handling apparatus attached to the vehicle main body and configured to support a load; and
the vibration suppression system for a loading vehicle according to claim 1.
